(19) United States
(12) Patent Application Publication
(10) Pub. No.: US 2004/0105999 A1
(43) Pub. Date: Jun. 3, 2004

(54) Bi-metallic macro composite

(76) Inventors: Stanley Abkowitz, Lexington, MA (US); Susan M. Abkowitz, Burlington, MA (US)

Correspondence Address: Finnegan, Henderson, Farabow,, Garrett & Dunner, L.L.P., 1300 I Street, N.W., Washington, DC, 20005-3315, US

(21) Appl. No.: 10/638,383

(22) Filed: Aug. 12, 2003

Related U.S. Application Data
(63) Continuation-in-part of application No. 09/988,623, filed on Nov. 20, 2001, now Pat. No. 6,620,523.
Application No. 09/988,623 is a continuation of application No. 08/672,629, filed on Jun. 28, 1996, now Pat. No. 6,318,738.
(60) Provisional application No. 60/000,651, filed on Jun. 29, 1995.

(51) Int. Cl. B32B 15/00

(52) U.S. Cl. 428/660; 428/629; 419/6

(57) ABSTRACT

A composite article and a method for making it are described. A clad structure composed of Zr and Ti is produced by cladding zirconium to a titanium surface. The surface can be either commercially pure titanium or a titanium alloy, such as Ti-6Al-4V, and may be manufactured by powder metallurgy techniques into barstock material or a shaped perform, which may be subsequently forged, extruded, or rolled.

This application is a continuation-in-part of U.S. application Ser. No. 09/988,623, filed on Nov. 20, 2001, which is a continuation application of U.S. application Ser. No. 08/672,629, filed on Jun. 28, 1996, now U.S. Pat. No. 6,318,738, which claims priority under 35 U.S.C. §119(e) to U.S. provisional application No. 60/000,651, filed Jun. 29, 1995, all of which are incorporated herein by reference.

Embodiments consistent with the present invention include macro-composite materials, such as zirconium-clad, titanium-core composites. Additional embodiments relate to articles formed from these macro-composites, as well as methods of making such macro-composites.

Zirconium metal has successfully been employed in several commercial applications because of its desirable properties, particularly its excellent corrosion resistance. The corrosion resistance and other desirable properties of zirconium and its alloys derive from an easily formed regenerating adherent oxide film. Based upon these advantages, zirconium has long been the material of choice in nuclear reactors and other industrial applications. This material is also recently finding application in orthopedic applications as an implant material intentionally oxidized to provide a thick oxide surface layer. The resulting high hardness and wear resistance substantially reduces the metallic or polymer wear debris which develops from the articulating surfaces in implant systems such as those which exist in total hip replacement.

While possessing advantageous surface properties, zirconium and its alloys have some inferior or limited bulk properties relative to other implant materials, such as, for example, titanium and its alloys (particularly Ti-6Al-4V) which are currently the material of choice for orthopedic applications. In particular, zirconium has a density of 6.49 g/cm³ (0.234 lb/in³) versus titanium's 4.51 g/cm³ (0.163 lb/in³) making it over 40% heavier than titanium. Additionally, zirconium offers significantly lower strength (approximately 75 ksi yield in the wrought condition) versus the Ti-6Al-4V alloy (at 120 ksi yield typical).

To take advantage of the beneficial properties associated with zirconium and titanium, and alloys thereof, there is a need for a macro-composite composed of zirconium and titanium. Such composites can be used in a wide range of applications in which a material is subjected to mechanical stresses and strains. In addition to prosthetic applications, other non-limiting examples of uses for the inventive macro-composite include corrosion resistant products, such as heat exchangers, drying columns, reactor vessels, piping, pumps, and valves. It is understood that depending on the application, the Zr cladding may comprise an interior surface, such as when used in pipes or tubes that carry corrosive materials.

Other applications require a high hardness, oxidized surface that promotes wear resistant properties. In addition to prosthetic applications, these applications include automotive valves, ice skate blades, knife blades, and golf club heads. For example, due to quick acceleration, sharp turning and sudden stopping, ice skate blades are often subjected to severe mechanical stresses and strains. In addition to requiring a hard edge, these movements subject the skate blades to extreme bending and torsional stresses. Furthermore, skate blades are continually exposed to melted ice, requiring the blade material to be rust-proof and corrosion resistant, as well as strong and lightweight.

Accordingly, the present invention is directed to a material system where the advantages of a titanium material with a zirconium clad layer formed thereon can be utilized to achieve a superior structure. The titanium material can be commercially pure titanium metal, or any of its alloys, including Ti-6Al-4V. This material can be produced by powder metallurgy techniques, as a near net shaped preform, or as a preform billet for rolling, forging, or extrusion. In such embodiments, the zirconium layer is then clad onto the titanium material, advantageously by a powder metallurgy method, thereby forming the bimetallic macrocomposite structure. If an alloy is to be produced by a powder metallurgy method, alloy powders may be compacted, or elemental powders of the constituent materials may be blended prior to pressing.

It is to be understood that both the foregoing general description and the following detailed description are exemplary and explanatory, and are not restrictive of the invention as claimed.

Titanium is an excellent material from the standpoint of its strength and fracture resistance. It is also remarkably lightweight. Because of these properties it is ideally suited for use as the base or substrate material for several embodiments. As used herein, “titanium material” refers to any titanium based material such as commercially pure titanium, titanium alloys and titanium matrix composites.

An exemplary titanium material for the purposes of this invention is a titanium alloy of Ti-6Al-4V. In certain embodiments, this alloy can be used as the matrix for a composite with Ti-containing particles dispersed therein. Such a composite may be produced by powder metallurgy techniques, and is described in U.S. Pat. No. 4,371,115, incorporated herein by reference.

Specific examples of titanium matrix composites are materials having a matrix of Ti-6Al-4V with 5%, 10%, 15%, 20%, or 25% TiC, TiB and/or TiB₂. The amount of the Ti-containing particle may be found in ranges of these percentages, or may vary from these percentages depending on the application.

Zirconium has excellent corrosion and wear resistance. It's bulk properties, however, are not as good as a titanium based material and its cost is significantly higher. When titanium material is clad with layers of zirconium, the resulting composite is lightweight, strong, and resistant to fracture, corrosion, wear, and less costly.

Other composites may also be used to practice the invention. These composites and methods for manufacturing and cladding them are disclosed in U.S. Pat. Nos. 4,906,430 and 4,968,348, each of which is incorporated herein by reference. Thus, according to the present invention, a composite comprised of a titanium material with reinforcing TiC, TiB₂ or TiB may be produced. Advantageously, these materials may be made by powder metallurgy techniques.

When using a powder metallurgy method according to one embodiment, zirconium powder, such as a commercially available zirconium powder having an irregular morphology (non-spherical) and a maximum particle size of 150 μm, is cold isostatically pressed around pure titanium or a titanium alloy preform, thereby forming a composite compact. In another embodiment, the titanium alloy is Ti-6Al-4V and may be produced by cold isostatically pressing mixed elemental or master alloy powders of the constituents.

The composite compact is then vacuum sintered at temperatures of about 2200° F.-2300° F. for about 2 to about 4 hours to simultaneously form the blended titanium alloy from elemental powders, the zirconium metal or alloy clad, and to diffusion bond the zirconium clad to the titanium core. This results in a strong bond forming between these materials and a minimal, non-detrimental reaction zone between the compatible titanium and zirconium layers. The structure may then be hot isostatically pressed, and either forged or machined to final dimensions, if desired.

Similarly, a zirconium (or an alloy thereof) core may be clad with titanium (or an alloy thereof) where the specific properties of the zirconium are desired on the interior of the composite. As an example, a bimetallic tube having an interior surface of zirconium may be formed. This type of tube is beneficial for carrying corrosive materials.

As an example of the above process, a titanium cold isostatic pressed bar is pressed at 30,000 psi and repressed with an outer layer of zirconium at 55,000 psi and vacuum sintered at 2250° F. for 2.5 hours. The result is a high density titanium core integrally clad with high density zirconium. The composite bar may be hot isostatically pressed to a still greater density.

Consistent with embodiments of this invention, a wide range of articles which would utilize this bimetallic composite structure, could be developed. For example, uses for the inventive macro-composite include corrosion resistant products, such as heat exchangers, drying columns, reactor vessels, piping, pumps, and valves.

Other applications require a high hardness, oxidized Zr surface. In such applications, a Zr oxide layer having a thickness sufficient to promotes wear resistant properties is formed on the surface of the bimetallic composite structure. Typical thicknesses of the Zr oxide layer may be up to 10 μm, advantageously from about 0.5 μm to about 7 μm, and 1 μm to about 5 μm. Methods of making thick Zr oxide layers are disclosed in U.S. Pat. No. 5,037,438, which is herein incorporated by reference. Non-limiting examples of such articles that have a thick Zr oxide layer include:

Surgical Implants—A ball component of a total hip replacement to provide a lightweight, high-strength, wear-resistant surface, wherein the core is a titanium alloy and the surface is a cladding of zirconium (oxidized) for high hardness.

Ice Skate Blades—A lightweight, high-strength, fracture-tough, high-hardness blade with good edge retention, wherein the titanium alloy is sandwiched between layers of zirconium which is oxidized on its surfaces to produce high-hardness edge quality, or wherein the bottom edge of the blade is zirconium and the remaining upper blade section is titanium.

Automotive Valves—A lightweight, high wear-resistant valve wherein the core of the valve is composed of titanium alloy and the surface is composed of zirconium which is oxidized to provide an antigalling surface, thus producing a lightweight valve offering improved engine efficiency and increased fuel economy.

Knife Blades—A lightweight, fracture-tough knife with superior sharpness, edge retention, and corrosion resistance, wherein the cutting edge is composed of zirconium (oxidized) bonded to a ductile titanium alloy shaft.

Golf Clubs—A lightweight golf club wherein the club head is titanium alloy and the face is zirconium which is oxidized to provide a high-hardness striking surface.

It will be apparent to those skilled in the art that various modifications and variations can be made in the disclosed process and product without departing from the scope or spirit of the invention. Other embodiments of the invention will be apparent to those skilled in the art from consideration of the specification and practice of the invention disclosed herein. It is intended that the specification and examples be considered as exemplary only.

What is claimed is:

1. A bimetallic composite material comprised of a titanium material with a zirconium containing layer formed thereon.

2. The bimetallic composite material of claim 1, wherein the titanium material comprises a titanium alloy.

3. The bimetallic composite material of claim 2, wherein the titanium alloy is Ti-6Al-4V.

4. The bimetallic composite material of claim 2, wherein the titanium alloy further comprises at least one particle of TiC, TiB, or TiB₂ to form a titanium matrix composite.

5. The bimetallic composite material of claim 4, wherein said at least one particle is present in an amount of greater than zero up to and including 25% by weight of said titanium matrix composite.

6. The bimetallic composite material of claim 5, wherein said at least one particle is present in an amount from about 5% to about 15% by weight of said titanium matrix composite.

7. The bimetallic composite material of claim 1, wherein the zirconium containing layer comprises zirconium or a zirconium alloy.

8. The bimetallic composite material of claim 7, wherein the zirconium containing layer further comprises a zirconium oxide layer having a thickness up to about 10 μm.

9. The bimetallic composite material of claim 8, wherein the thickness of the zirconium oxide layer is in the range of about 1 μm to about 5 μm.

10. An article comprising a bimetallic composite material, said bimetallic composite material comprising a titanium material with a zirconium containing layer formed thereon.

11. The article of claim 10, wherein the zirconium containing layer further comprises a zirconium oxide layer having a thickness up to about 10 μm.

12. The article of claim 11, wherein said article is a prosthetic device.

13. The article of claim 12, wherein the prosthetic device comprises a ball and joint component of an artificial hip.

14. The article of claim 11, wherein said article is an automotive component, a knife blade, or a golf club head.

15. The article of claim 10, wherein said article is a heat exchanger, a drying column, a reactor vessel, a pipe, a pump, or a valve.

16. A method of making a composite material, comprising;
providing a titanium material; and
cladding a zirconium material to said titanium material.

17. The method of claim 16, wherein said titanium material is commercially pure titanium or a titanium alloy.

18. The method of claim 17, wherein said titanium alloy is Ti-6Al-4V.

19. The method of claim 16, wherein the zirconium material comprises zirconium or a zirconium alloy.

20. The method of claim 19, wherein the zirconium containing layer further comprises a zirconium oxide layer having a thickness up to about 10 μm.

21. The method of claim 20 wherein the thickness of the zirconium oxide layer is in the range of about 1 μm to about 5 μm.

22. The method of claim 16, wherein the titanium material is manufactured by powder metallurgy into barstock material, or is a near net shaped preform for subsequent forging, extrusion, or rolling.

23. The method of claim 22, wherein the powder metallurgy technique comprises blending titanium material powders, and pressing the powders to form said preform.

24. The method of claim 23, wherein said titanium preform is produced by cold isostatically pressing commercially pure titanium powder or titanium alloy powder at a pressure above about 25,000 psi.

25. The method of claim 24, wherein said titanium alloy powder comprises Ti-6Al-4V.

26. The method of claim 20, wherein said zirconium material is clad to the barstock material or the near net shaped preform by cold isostatically pressing zirconium material powders at a pressure above about 50,000 psi around said barstock material or said near net shaped preform.

27. The method of claim 26, further comprising vacuum sintering after the zirconium material is pressed around the titanium preform.

28. The method of claim 27, wherein said vacuum sintering is performed at temperatures ranging from about 2200° F. to about 2300° F. for a time ranging from about 2 to about 4 hours to produce a product comprising a high density titanium core integrally clad with high density zirconium.

29. The method claim 28, wherein said product is subsequently hot isostatically pressed.

30. The method of claim 16, wherein said zirconium material powder comprises an irregular morphology and a particle size above about 150 μm.
